(19) United States
(12) Patent Application Publication
(10) Pub. No.: US 2026/0312875 A1
(43) Pub. Date: Oct. 8, 2026

(54) FACILITATION OF ANALYTICS IN ROAMING SCENARIOS

(71) Applicant: NOKIA TECHNOLOGIES OY, Espoo (FI)

(72) Inventor: Horst Thomas BELLING, Munich (DE)

(21) Appl. No.: 19/483,392

(22) PCT Filed: May 13, 2024
(86) PCT No.: PCT/IB2024/054611

§ 371 Date: Nov. 11, 2025

(30) Foreign Application Priority Data
May 12, 2023 (GB) 2307078.2

(51) Int. Cl. H04L 41/14; H04W 8/20; H04W 8/24; H04W 24/10

(52) U.S. Cl. CPC H04L 41/14; H04W 8/20; H04W 8/24; H04W 24/10

(57) ABSTRACT

There are provided measures for facilitation of analytics in roaming scenarios. Such measures exemplarily comprise, in a first network, receiving a first demand for analytics information in relation to a terminal roaming in a second network, determining information on at least one network element in said second network, said at least one network element serving said terminal, and deciding to transmit a second demand for said analytics information towards said second network, wherein said second demand includes said information on said at least one network element.

### RELATED APPLICATIONS

This application claims the benefit of priority of United Kingdom Patent Application No. 2307078.2 filed May 12, 2023, which is hereby incorporated by reference as if reproduced in its entirety.

### TECHNICAL FIELD

Various example embodiments relate to facilitation of analytics in roaming scenarios. More specifically, various example embodiments exemplarily relate to measures (including methods, apparatuses and computer program products) for realizing facilitation of analytics in roaming scenarios.

### BACKGROUND

The present specification generally relates to exposure of analytics related to a roaming terminal (e.g., a user equipment) between a visited network and a home network.

To generate analytics related to an inbound roaming UE, a network data analytics function (NWDAF) (otherwise referred to as a network data analytics entity) of a visited public land mobile network (VPLMN) needs to identify network functions (otherwise referred to as network entities) of the VPLMN (e.g., an access and mobility function (AMF) (otherwise referred to as an access and mobility entity) and, if local breakout is used, a session management function (SMF) (otherwise referred to as a session management entity) serving the inbound roaming UE and obtain information (e.g., data) from the identified network functions (e.g., network entities) of the VPLMN.

The information obtained is stored in the unified data management (UDM) entity of the home public land mobile network (HPLMN).

However, access to the information stored in the UDM may be restricted for network functions (e.g., network entities) of another PLMN (e.g., network function (e.g., network entities) of the VPLMN).

Signaling is exchanged where an analytics request of the HPLMN triggers the VPLMN to request information from the HPLMN to answer the request analytics leads to excessive amounts of signaling messages.

Hence, the problem arises that, in roaming scenarios, analytics related to the roaming terminal may not be generated and/or provided or may be incomplete due to lacking information from e.g., involved network function (e.g., network entities) such as AMF, SMF. Obtaining this information which is lacking may lead to additional and/or increased signaling between networks function (e.g., network entities) of a HPLMN and a VPLMN.

Hence, there is a need to provide for facilitation of analytics in roaming scenarios (e.g., when a UE is roaming).

### SUMMARY

Various example embodiments aim at addressing at least part of the above issues and/or problems and drawbacks.

Various aspects of example embodiments are set out in the appended claims.

According to an exemplary aspect, there is provided a method in a first network, the method comprising receiving a first demand for analytics information in relation to a terminal roaming in a second network, determining information on at least one network element in said second network, said at least one network element serving said terminal, and deciding to transmit a second demand for said analytics information towards said second network, wherein said second demand includes said information on said at least one network element.

According to an exemplary aspect, there is provided a method in a second network, the method comprising receiving a first demand for analytics information in relation to a first network based terminal roaming in said second network, wherein said first demand includes information on at least one network element in said second network, said at least one network element serving said terminal, and transmitting a first analytics information message including said analytics information.

According to an exemplary aspect, there is provided an apparatus in a first network, the apparatus comprising receiving circuitry configured to receive a first demand for analytics information in relation to a terminal roaming in a second network, determining circuitry configured to determine information on at least one network element in said second network, said at least one network element serving said terminal, and deciding circuitry configured to decide to transmit a second demand for said analytics information towards said second network, wherein said second demand includes said information on said at least one network element.

According to an exemplary aspect, there is provided an apparatus in a second network, the apparatus comprising receiving circuitry configured to receive a first demand for analytics information in relation to a first network based terminal roaming in said second network, wherein said first demand includes information on at least one network element in said second network, said at least one network element serving said terminal, and transmitting circuitry configured to transmit a first analytics information message including said analytics information.

According to an exemplary aspect, there is provided an apparatus in a first network, the apparatus comprising at least one processor, at least one memory including computer program code, and at least one interface configured for communication with at least another apparatus, the at least one processor, with the at least one memory and the computer program code, being configured to cause the apparatus to perform receiving a first demand for analytics information in relation to a terminal roaming in a second network, determining information on at least one network element in said second network, said at least one network element serving said terminal, and deciding to transmit a second demand for said analytics information towards said second network, wherein said second demand includes said information on said at least one network element.

According to an exemplary aspect, there is provided an apparatus in a second network, the apparatus comprising at least one processor, at least one memory including computer program code, and at least one interface configured for communication with at least another apparatus, the at least one processor, with the at least one memory and the computer program code, being configured to cause the apparatus to perform receiving a first demand for analytics information in relation to a first network based terminal roaming in said second network, wherein said first demand includes information on at least one network element in said second network, said at least one network element serving said terminal, and transmitting a first analytics information message including said analytics information.

According to an exemplary aspect, there is provided an apparatus in a first network, the apparatus comprising means for receiving a first demand for analytics information in relation to a terminal roaming in a second network, means for determining information on at least one network element in said second network, said at least one network element serving said terminal, and means for deciding to transmit a second demand for said analytics information towards said second network, wherein said second demand includes said information on said at least one network element.

According to an exemplary aspect, there is provided an apparatus in a second network, the apparatus comprising means for receiving a first demand for analytics information in relation to a first network based terminal roaming in said second network, wherein said first demand includes information on at least one network element in said second network, said at least one network element serving said terminal, and means for transmitting a first analytics information message including said analytics information.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient provision of information and an improvement of signaling efficiency to thereby solve at least part of the problems and drawbacks identified in relation to the prior art.

By way of example embodiments, there is provided facilitation of analytics in roaming scenarios. More specifically, by way of example embodiments, there are provided measures and mechanisms for realizing facilitation of analytics in roaming scenarios.

Thus, improvement is achieved by methods, apparatuses and computer program products enabling/realizing facilitation of analytics in roaming scenarios.

### BRIEF DESCRIPTION OF THE DRAWINGS

In the following, the present disclosure will be described in greater detail by way of non-limiting examples with reference to the accompanying drawings, in which:

FIG. 1 is a block diagram illustrating an apparatus according to example embodiments;

FIG. 2 is a block diagram illustrating an apparatus according to example embodiments;

FIG. 3 is a block diagram illustrating an apparatus according to example embodiments;

FIG. 4 is a block diagram illustrating an apparatus according to example embodiments;

FIG. 5 is a schematic diagram of a procedure according to example embodiments;

FIG. 6 is a schematic diagram of a procedure according to example embodiments;

FIG. 7 shows a schematic diagram of signaling sequences according to example embodiments;

FIG. 8 shows a schematic diagram of signaling sequences according to example embodiments; and

FIG. 9 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following:” and “at least one of” and similar wording, where the list of two or more elements are joined by “and” or “or”, mean at least any one of the elements, or at least any two or more of the elements, or at least all the elements.

According to example embodiments, in general terms, there are provided measures and mechanisms for (enabling/realizing) facilitation of analytics in roaming scenarios.

In brief, according to example embodiments, when receiving a request for, or a subscription to, analytics, an NWDAF with roaming entry capability in the HPLMN (home roaming entry network data analytics function (H-RE-NWDAF)) sends a query to the UDM for information about the AMF(s) and SMF(s) serving the UE(s) indicated as target of analytics reporting, and identifies the VPLMN serving the UE(s) based on the received globally unique access and mobility function identifier(s) (GUAMI) of the AMF(s).

The H-RE-NWDAF sends a roaming analytics request (e.g., a request for roaming analytics), a subscription request for a subscription to provide notifications of roaming analytics, or a request for input data to an NWDAF configured with roaming entry capability in the VPLMN (generally referred to as a visited roaming entry network data analytics function (V-RE-NWDAF)), and indicates the identifiers (IDs) of AMFs, and, for local breakout, the identifiers (IDs) of SMFs, in the VPLMN handling the related UE(s), that are obtained from the UDM.

The V-RE-NWDAF collects data from the indicated AMF(s) and/or SMF(s) and, for an analytics request, derives the requested analytics from the collected data, and provides the analytics or requested input data to the H-RE-NWDAF.

Example embodiments are specified below in more detail.

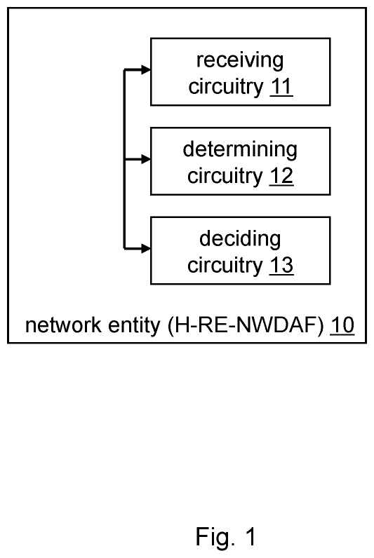

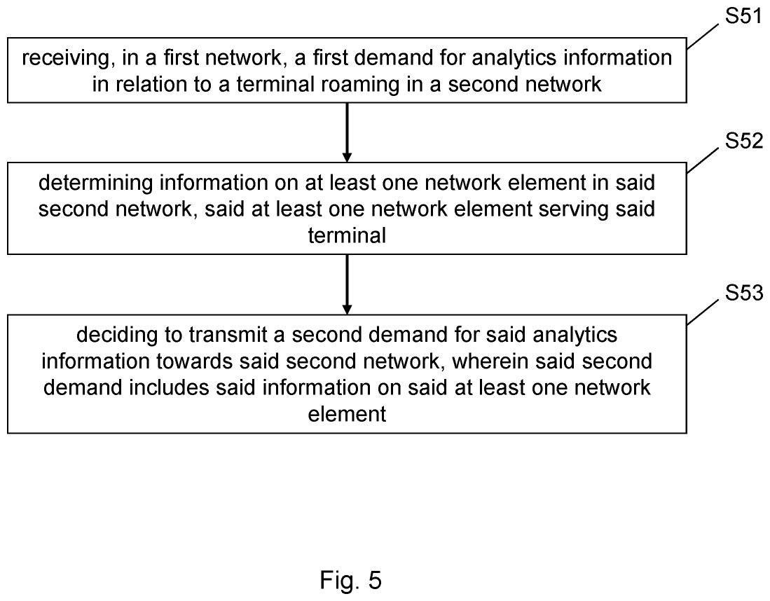

FIG. 1 is a block diagram illustrating an apparatus according to example embodiments. The apparatus may be a network node or entity 10 (such as a home roaming network data analytics entity or a network node or entity comprising a home roaming network data analytics function) (in a first network) comprising a receiving circuitry 11, a determining circuitry 12, and a deciding circuitry 13. The receiving circuitry 11 receives a first demand for analytics information in relation to a terminal roaming in a second network. The determining circuitry 12 determines information on at least one network element in said second network, said at least one network element serving said terminal. The deciding circuitry 13 decides to transmit a second demand for said analytics information towards said second network. Here, the second demand includes said information on said at least one network element. FIG. 5 is a schematic diagram of a procedure according to example embodiments. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to example embodiments comprises an operation of receiving (S51) a first demand for analytics information in relation to a terminal roaming in a second network, an operation of determining (S52) information on at least one network element in said second network, said at least one network element serving said terminal, and an operation of deciding (S53) to transmit a second demand for said analytics information towards said second network. Here, the second demand includes said information on said at least one network element.

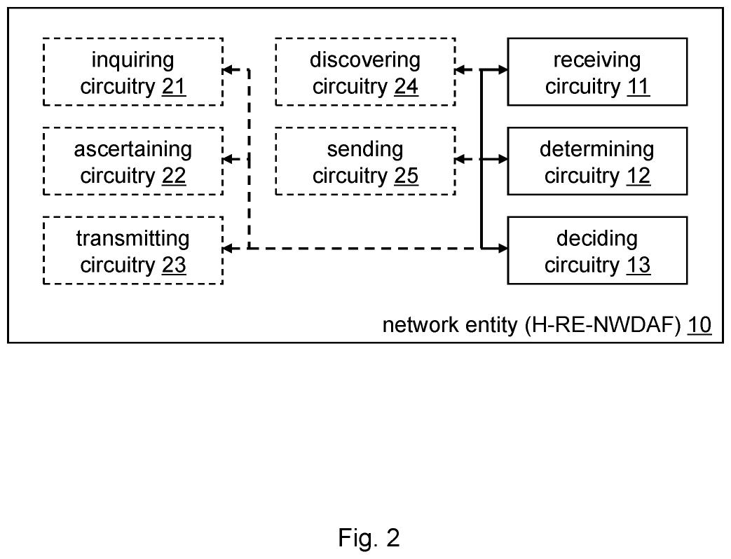

FIG. 2 is a block diagram illustrating an apparatus according to example embodiments. In particular, FIG. 2 illustrates a variation of the apparatus shown in FIG. 1. The apparatus according to FIG. 2 may thus further comprise an inquiring circuitry 21, an ascertaining circuitry 22, a transmitting circuitry 23, a discovering circuitry 24, and/or a sending circuitry 25.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary details of the determining operation (S52) are given, which are inherently independent from each other as such. Such exemplary determining operation (S52) according to example embodiments may comprise an operation of inquiring, from a data management entity, said information on said at least one network element, and an operation of receiving, from said data management entity, said information on said at least one network element.

According to a variation of the procedure shown in FIG. 5, exemplary details of the deciding operation (S53) and exemplary additional operations are given, which are inherently independent from each other as such. According to such variation, such exemplary deciding operation (S53) according to example embodiments may comprise an operation of ascertaining whether said analytics information are required to be provided by said second network. Further, an exemplary method according to example embodiments may comprise an operation of transmitting, if said analytics information are required to be provided by said second network, said second demand for said analytics information towards said second network.

According to a variation of the procedure shown in FIG. 5, exemplary additional operations and exemplary details of the transmitting operation are given, which are inherently independent from each other as such. According to such variation, an exemplary method according to example embodiments may comprise an operation of discovering a data analytics function entity in said second network, the data analytics function entity having a predetermined capability. Further, such exemplary transmitting operation according to example embodiments may comprise an operation of sending said second demand for said analytics information towards said data analytics function entity.

According to further example embodiments, said predetermined capability is a roaming entry capability.

According to a variation of the procedure shown in FIG. 5, exemplary additional operations are given, which are inherently independent from each other as such. According to such variation, an exemplary method according to example embodiments may comprise an operation of receiving, from said second network, a first analytics information message including said analytics information.

According to further example embodiments, said first analytics information message is a first analytics response or a first analytics notification.

According to a variation of the procedure shown in FIG. 5, exemplary additional operations are given, which are inherently independent from each other as such. According to such variation, an exemplary method according to example embodiments may comprise an operation of transmitting a second analytics information message including said analytics information.

According to further example embodiments, said second analytics information message is a second analytics response or a second analytics notification.

According to further example embodiments, said at least one network element is an access and mobility management function (otherwise referred to as an access and mobility management entity or a session management function (otherwise referred to as a session management entity).

According to further example embodiments, said first demand is a first analytics request or a first analytics subscription.

According to further example embodiments, said second demand is a second analytics request or a second analytics subscription.

According to further example embodiments, said information on said at least one network element includes at least one network element identifier corresponding to said at least one network element.

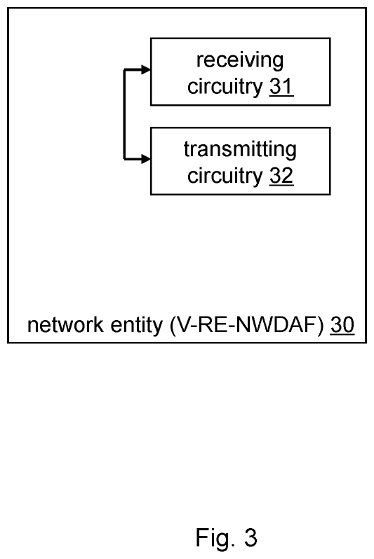

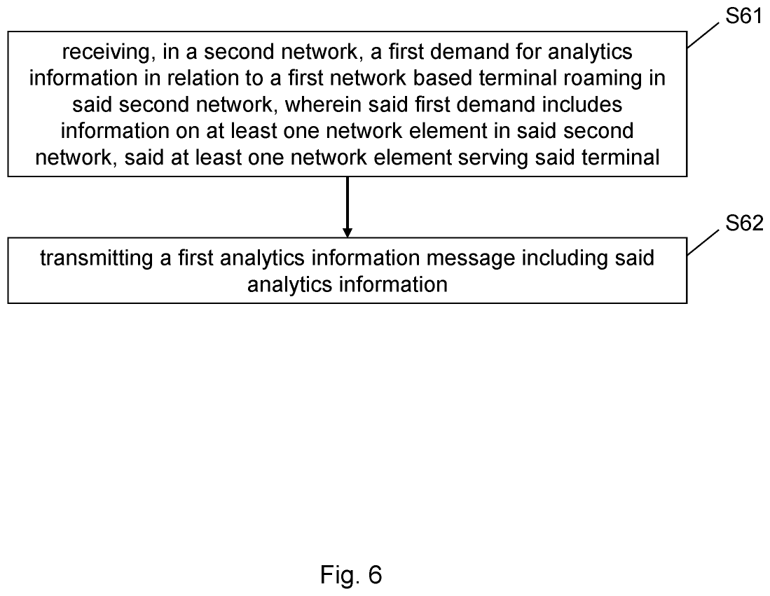

FIG. 3 is a block diagram illustrating an apparatus according to example embodiments. The apparatus may be a network node or entity 30 (such as a visited roaming network data analytics entity or a network node or entity comprising access and mobility management function) (in a second network) comprising a receiving circuitry 31 and a transmitting circuitry 32. The receiving circuitry 31 receives a first demand for analytics information in relation to a first network based terminal roaming in said second network, wherein said first demand includes information on at least one network element in said second network, said at least one network element serving said terminal. The transmitting circuitry 32 transmits a first analytics information message including said analytics information. FIG. 6 is a schematic diagram of a procedure according to example embodiments. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to example embodiments comprises an operation of receiving (S61) a first demand for analytics information in relation to a first network based terminal roaming in said second network, wherein said first demand includes information on at least one network element in said second network, said at least one network element serving said terminal, and an operation of transmitting (S62) a first analytics information message including said analytics information.

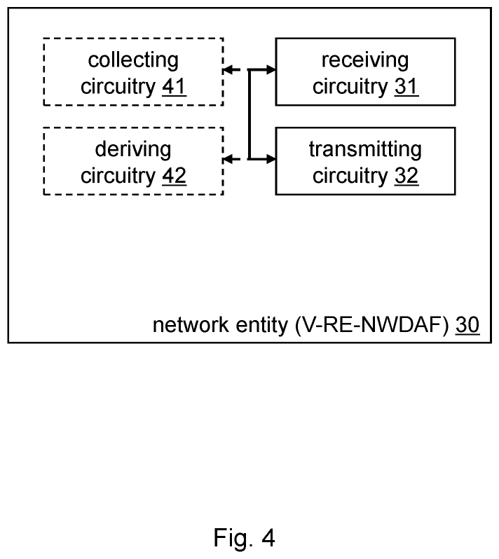

FIG. 4 is a block diagram illustrating an apparatus according to example embodiments. In particular, FIG. 4 illustrates a variation of the apparatus shown in FIG. 3. The apparatus according to FIG. 4 may thus further comprise a collecting circuitry 41 and/or a deriving circuitry 42.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary additional operations are given, which are inherently independent from each other as such. According to such variation, an exemplary method according to example embodiments may comprise an operation of collecting data from said at least one network element, and an operation of deriving said analytics information based on said data.

According to a variation of the procedure shown in FIG. 6, exemplary additional operations are given, which are inherently independent from each other as such. According to such variation, an exemplary method according to example embodiments may comprise an operation of transmitting a second demand for said analytics information towards a data analytics function. Here, said second demand includes said information on said at least one network element.

According to further example embodiments, said second demand is a second analytics request or a second analytics subscription.

According to a variation of the procedure shown in FIG. 6, exemplary additional operations are given, which are inherently independent from each other as such. According to such variation, an exemplary method according to example embodiments may comprise an operation of receiving, from said data analytics function, a second analytics information message including said analytics information.

According to further example embodiments, said second analytics information message is a second analytics response or a second analytics notification.

According to further example embodiments, said at least one network element is an access and mobility management function entity or a session management function entity.

According to further example embodiments, said first demand is a first analytics request or a first analytics subscription.

According to further example embodiments, said first analytics information message is a first analytics response or a first analytics notification.

According to further example embodiments, said information on said at least one network element includes at least one network element identifier corresponding to said at least one network element.

Example embodiments outlined and specified above are explained below in more specific terms.

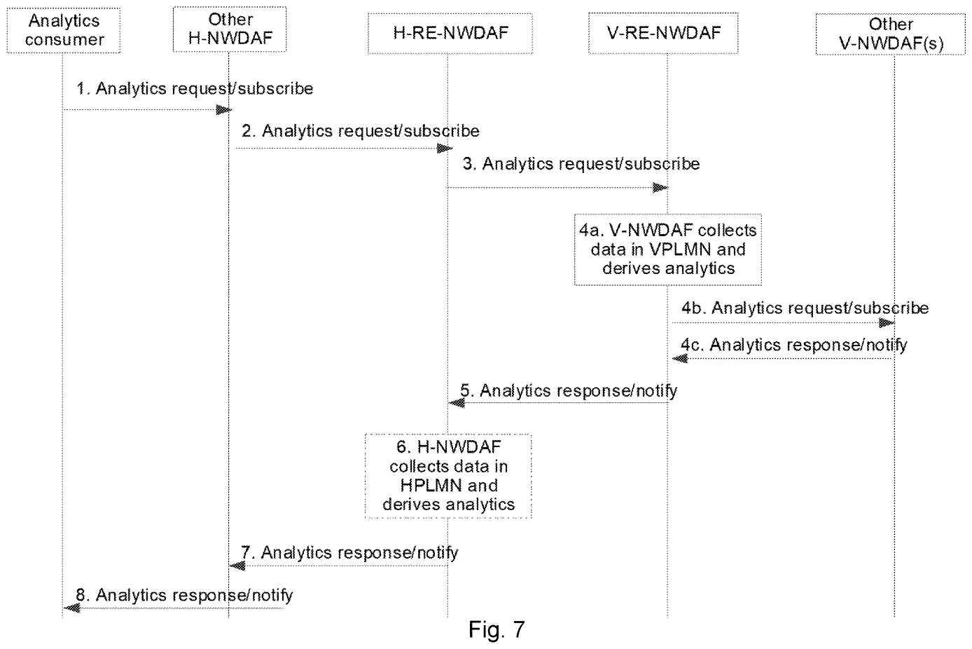

FIG. 7 shows a schematic diagram of signaling sequences according to example embodiments, and in particular illustrates a procedure for analytics exposure from a VPLMN to an HPLMN.

In step 1 of FIG. 7, according to example embodiments, an analytics consumer network function (NF) (e.g., a NF service consumer of an analytics service provided by a NF service producer) in HPLMN (e.g. home policy control function (H-PCF)) or attached to HPLMN (e.g. an external application function (AF) requesting analytics via the Nnef_AnalyticsExposure service) sends an analytics request and/or a subscription request for analytics (including e.g. an identity of the analytics (i.e., an analytics ID), (a) target(s) of analytics reporting, analytics filter information) to an H-NWDAF by invoking e.g. a Nnwdaf_AnalyticsInfo_Request and/or a Nnwdaf_AnalyticsSubscription_Subscribe service operations. If the analytics consumer NF in HPLMN is aware that the request relates to outbound roaming users or NFs in another public land mobile network (PLMN), the analytics consumer NF may discover an H-NWDAF with roaming entry capability (H-RE-NWDAF) and may direct the request towards the H-RE-NWDAF. In such case, step 2 of FIG. 7 explained below would be skipped.

In step 2 of FIG. 7, according to example embodiments, the H-NWDAF discovers that the analytics request/subscription relates to one or several outbound roaming UEs (e.g. by inquiring the AMF serving a related user at the UDM e.g. with the Nudm_UECM service) or NFs in another PLMN. The H-NWDAF discovers an H-RE-NWDAF and forwards the analytics request/subscription to the H-RE-NWDAF. The H-NWDAF may include the VPLMN ID and/or the AMF IDs in the analytics request/subscription.

In step 3 of FIG. 7, according to example embodiments, the H-RE-NWDAF inquires at the UDM (e.g. with the Nudm_UECM service operation) for the AMF(s) and SMF(s) serving the UEs indicated as target(s) of analytics reporting and derives the VPLMN based on the received GUAMI(s) of the AMF(s).

According to example embodiments, the H-RE-NWDAF determines based on e.g., operator configuration and nature of the requested analytics whether analytics or input data from the VPLMN are required, or whether the analytics can be derived locally.

If analytics from the VPLMN are required, it is proceeded further with the subsequent steps of FIG. 7.

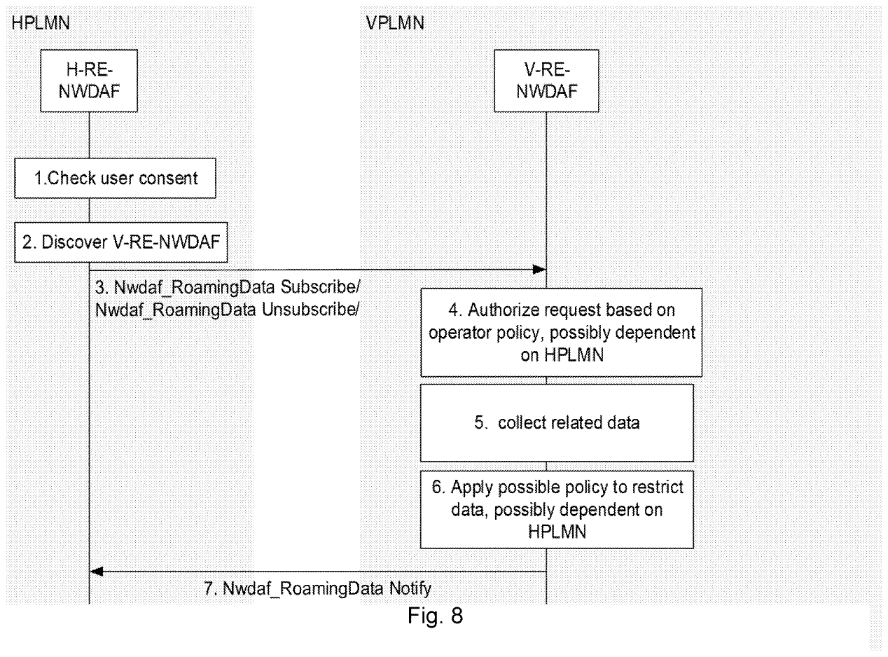

If input data from the VPLMN are required, it is proceeded further with the procedure of FIG. 8 explained below.

According to example embodiments, the H-RE-NWDAF checks user consent for analytics. Further, the H-NWDAF checks policies and regulatory constraints between the HPLMN and the VPLMN to determine whether the roaming analytics request/subscribe can be accepted or must be rejected. If the request is to be rejected, the following steps of FIG. 7 would be skipped.

According to example embodiments, the H-RE-NWDAF discovers a V-RE-NWDAF with roaming entry capability.

Further, according to example embodiments, the H-RE-NWDAF sends a roaming analytics request/subscribe (including e.g. an analytics ID, analytics filter information, AMF ID(s), SMF ID(s) (if applicable)) to the V-NWDAF (e.g. by invoking an Nnwdaf_RoamingAnalytics_Request service operation or an Nnwdaf_RoamingAnalytics_Subscribe service operation), based on the received analytics request/subscription. In particular, according to example embodiments, the H-RE-NWDAF indicates the IDs of AMFs, and, for local breakout, the IDs of SMFs in the VPLMN handling related UEs, as obtained from the UDM.

In step 4a of FIG. 7, according to example embodiments, the V-RE-NWDAF checks the policies and regulatory constraints between the HPLMN and the VPLMN, to determine whether the roaming analytics request/subscribe can be accepted or must be rejected. If the roaming analytics request/subscribe is to be rejected, the following steps of FIG. 7 would be skipped.

If the V-RE-NWDAF supports generating the requested analytics, the V-RE-NWDAF collects data from the NF(s) (as indicated via the AMF ID(s) or SMF ID(s)) and/or operations, administration and maintenance (OAM) entities in the VPLMN and derives (e.g., determines or computes) the analytics.

If the V-RE-NWDAF does not support generating the requested analytics, steps 4b and 4c of FIG. 7 would be executed.

In steps 4b and 4c of FIG. 7, according to example embodiments, in case the V-RE-NWDAF does not support generating the requested analytics, the V-RE-NWDAF may request/subscribe to other NWDAF(s) in the VPLMN (if available) for the analytics (providing received AMF ID(s) and SMF ID(s)) and get corresponding response/notification.

In step 5 of FIG. 7, according to example embodiments, the V-RE-NWDAF sends the VPLMN analytics information to the H-RE-NWDAF (e.g. using signalling or a control plane message such as Nnwdaf_RoamingAnalytics_Request or Nnwdaf_RoamingAnalytics_Notify, depending on the service used in step 2/3 of FIG. 7).

According to example embodiments, the V-RE-NWDAF may restrict the exposed analytics information based on VPLMN operator polices and may store the exposed information for auditing.

In step 6 of FIG. 7, according to example embodiments, the H-RE-NWDAF may collect data from the NF(s) and/or OAM in HPLMN to derive the requested analytics. This collecting can be executed in parallel with steps 3 to 5 of FIG. 7 explained above. This collecting can also be omitted.

In step 7 of FIG. 7, according to example embodiments, the H-RE-NWDAF sends analytics information derived from the VPLMN analytics information received in step 5 of Figure and/or derived from information possibly collected in step 6, to the H-NWDAF (if step 2 of FIG. 7 was not skipped) or directly to the analytics consumer NF (if step 2 of FIG. 7 was skipped) (e.g. using either Nnwdaf_AnalyticsInfo_Request response or Nnwdaf_AnalyticsSubscription_Notify, depending on the service used in step 1/2 of FIG. 7).

According to example embodiments, input data from the HPLMN and analytics from the VPLMN are combined. Such combination may be dependent on the nature of the requested analytics information.

According to example embodiments, analytics information can be derived locally if no analytics information from the VPLMN can be obtained. Such fallback may be dependent on the nature of the requested analytics information.

In step 8 of FIG. 7, if step 2 of FIG. 7 was executed (i.e. not skipped), according to example embodiments, the H-NWDAF sends the analytics information received in step 7 of FIG. 7 to the analytics consumer NF.

FIG. 8 shows a schematic diagram of signaling sequences according to example embodiments, and in particular illustrates data collection by an H-RE-NWDAF from a V-RE-NWDAF for outbound roaming users.

In step 1 of FIG. 8, according to example embodiments, for subscription to collected data related to the UE(s), the H-RE-NWDAF checks the user consent of related users.

In step 2 of FIG. 8, according to example embodiments, the H-RE-NWDAF of the HPLMN discovers a V-RE-NWDAF of a VPLMN that supports the Nwdaf_RoamingData service using a network repository function (NRF) entity.

The access to the Nnf_EventExposure services may be restricted to NF service consumers within the same PLMN to prevent bypassing checks based on user consent and operator policy.

In step 3 of FIG. 8, according to example embodiments, the H-RE-NWDAF subscribes/unsubscribes to notifications about input data (e.g. by invoking the Nnwdaf_RoamingData_Subscribe service operation and/or Nnwdaf_RoamingData_Unsubscribe service operation). Here, the H-RE-NWDAF indicates the identities or identifiers (IDs) of AMFs, and, for local breakout, identities or identifiers (IDs) of SMFs in the VPLMN handling related UEs, as obtained from the UDM.

In step 4 of FIG. 8, according to example embodiments, the V-RE-NWDAF checks whether the HPLMN is authorized to request the input data based on e.g. VPLMN operator polices (that may depend on the HPLMN and may indicate permissible or restricted input data and related parameters).

n step 5 of FIG. 8, according to example embodiments, the V-RE-NWDAF triggers new data collection from NF(s) (as indicated via the AMF ID(s) or SMF ID(s)) if needed and monitors the requested input data.

In step 6 of FIG. 8, according to example embodiments, the V-RE-NWDAF may restrict the exposed input data based on VPLMN operator polices (that may depend on the HPLMN) and may store them for auditing.

In step 7 of FIG. 8, according to example embodiments, the V-RE-NWDAF notifies input data to the H-RE-NWDAF.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e., the expression “unit configured to” is construed to be equivalent to an expression such as “means for”).

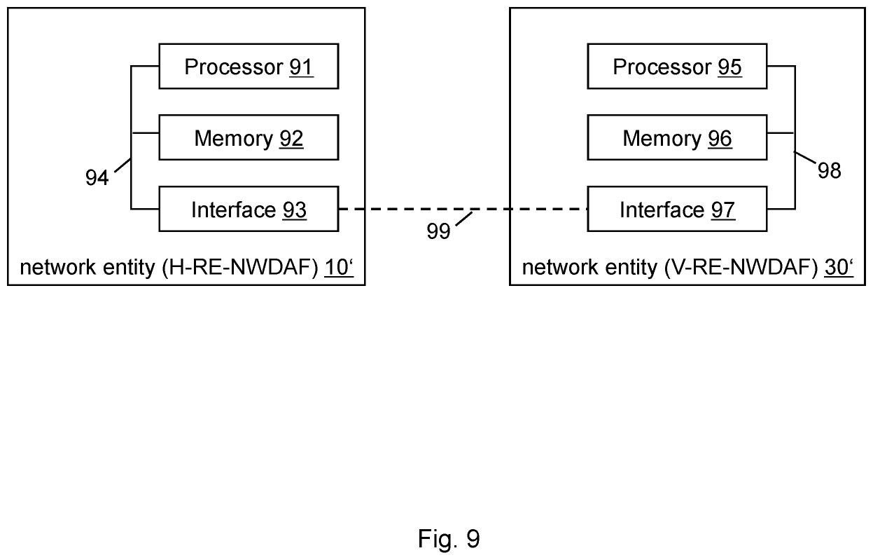

In FIG. 9, an alternative illustration of apparatuses according to example embodiments is depicted. As indicated in FIG. 9, according to example embodiments, the apparatus (network node or entity) 10′ (corresponding to the network node or entity 10) comprises a processor 91, a memory 92 and an interface 93, which are connected by a bus 94 or the like. Further, according to example embodiments, the apparatus (network node or entity) 30′ (corresponding to the network node or entity 30) comprises a processor 95, a memory 96 and an interface 97, which are connected by a bus 98 or the like, and the apparatuses may be connected via link 99, respectively.

The processor 91/95 and/or the interface 93/97 may also include a modem or the like to facilitate communication over a (hardwire or wireless) link, respectively. The interface 93/97 may include a suitable transceiver coupled to one or more antennas or communication means for (hardwire or wireless) communications with the linked or connected device(s), respectively. The interface 93/97 is generally configured to communicate with at least one other apparatus, i.e. the interface thereof.

The memory 92/96 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e., the expression “processor configured to [cause the apparatus to] perform xxx-ing” is construed to be equivalent to an expression such as “means for xxx-ing”).

According to example embodiments, an apparatus representing the network node or entity 10 (in a first network) comprises at least one processor 91, at least one memory 92 including computer program code, and at least one interface 93 configured for communication with at least another apparatus. The processor (i.e. the at least one processor 91, with the at least one memory 92 and the computer program code) is configured to perform receiving a first demand for analytics information in relation to a terminal roaming in a second network (thus the apparatus comprising corresponding means for receiving), to perform determining information on at least one network element in said second network, said at least one network element serving said terminal (thus the apparatus comprising corresponding means for determining), and to perform deciding to transmit a second demand for said analytics information towards said second network, wherein said second demand includes said information on said at least one network element (thus the apparatus comprising corresponding means for deciding).

According to example embodiments, an apparatus representing the network node or entity 30 (in a second network) comprises at least one processor 95, at least one memory 96 including computer program code, and at least one interface 97 configured for communication with at least another apparatus. The processor (i.e. the at least one processor 95, with the at least one memory 96 and the computer program code) is configured to perform receiving a first demand for analytics information in relation to a first network based terminal roaming in said second network, wherein said first demand includes information on at least one network element in said second network, said at least one network element serving said terminal (thus the apparatus comprising corresponding means for receiving), and to perform transmitting a first analytics information message including said analytics information (thus the apparatus comprising corresponding means for transmitting).

For further details regarding the operability/functionality of the individual apparatuses, reference is made to the above description in connection with any one of FIGS. 1 to 8, respectively.

For the purpose of the present disclosure as described herein above, it should be noted that:
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for facilitation of analytics in roaming scenarios. Such measures exemplarily comprise, in a first network, receiving a first demand for analytics information in relation to a terminal roaming in a second network, determining information on at least one network element in said second network, said at least one network element serving said terminal, and deciding to transmit a second demand for said analytics information towards said second network, wherein said second demand includes said information on said at least one network element.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

At least the following example Items are covered by what is disclosed and specified above.

Item 1. A method in a first network, the method comprising: receiving a first demand for analytics information in relation to a terminal roaming in a second network;
determining information on at least one network element in said second network, said at least one network element serving said terminal; and deciding to transmit a second demand for said analytics information towards said second network, wherein said second demand includes said information on said at least one network element.

Item 2. The method according to Item 1, wherein said determining, the comprises:
inquiring, from a data management entity, said information on said at least one network element; and
receiving, from said data management entity, said information on said at least one network element.

Item 3. The method according to Item 1 or 2, wherein said deciding further comprises ascertaining whether said analytics information are required to be provided by said second network; and wherein the method further comprises:
transmitting, if said analytics information are required to be provided by said second network, said second demand for said analytics information towards said second network.

Item 4. The method according to Item 3, further comprising:
discovering a data analytics function entity in said second network, the data analytics function entity having a predetermined capability, wherein said transmitting further comprises:
sending said second demand for said analytics information towards said data analytics function entity.

Item 5. The method according to Item 4, wherein said predetermined capability is a roaming entry capability.

Item 6. The method according to any of Items 1 to 5, further comprising:
receiving, from said second network, a first analytics information message including said analytics information.

Item 7. The method according to Item 6, wherein said first analytics information message is a first analytics response or a first analytics notification.

Item 8. The method according to Item 6 or 7, further comprising: transmitting a second analytics information message including said analytics information.

Item 9. The method according to Item 8, wherein said second analytics information message is a second analytics response or a second analytics notification.

Item 10. The method according to any of Items 1 to 9, wherein: said at least one network element is an access and mobility management function entity or a session management function entity; and/or said first demand is a first analytics request or a first analytics subscription; and/or
said second demand is a second analytics request or a second analytics subscription; and/or
said information on said at least one network element includes at least one network element identifier corresponding to said at least one network element.

Item 11. A method in a second network, the method comprising:
receiving a first demand for analytics information in relation to a first network based terminal roaming in said second network, wherein said first demand includes information on at least one network element in said second network, said at least one network element serving said terminal; and
transmitting a first analytics information message including said analytics information.

Item 12. The method according to Item 11, further comprising:
collecting data from said at least one network element; and
deriving said analytics information based on said data.

Item 13. The method according to Item 11, further comprising: transmitting a second demand for said analytics information towards a data analytics function, wherein said second demand includes said information on said at least one network element.

Item 14. The method according to Item 13, wherein said second demand is a second analytics request or a second analytics subscription.

Item 15. The method according to Item 13 or 14, further comprising:
receiving, from said data analytics function, a second analytics information message including said analytics information.

Item 16. The method according to Item 15, wherein said second analytics information message is a second analytics response or a second analytics notification.

Item 17. The method according to any of Items 11 to 16, wherein
said at least one network element is an access and mobility management function entity or a session management function entity; and/or
said first demand is a first analytics request or a first analytics subscription; and/or
said first analytics information message is a first analytics response or a first analytics notification; and/or
said information on said at least one network element includes at least one network element identifier corresponding to said at least one network element.

Item 18. An apparatus in a first network, the apparatus comprising:
receiving circuitry configured to receive a first demand for analytics information in relation to a terminal roaming in a second network;
determining circuitry configured to determine information on at least one network element in said second network, said at least one network element serving said terminal; and
deciding circuitry configured to decide to transmit a second demand for said analytics information towards said second network, wherein said second demand includes said information on said at least one network element.

Item 19. The apparatus according to Item 18, further comprising:
inquiring circuitry configured to inquire, from a data management entity, said information on said at least one network element; and
receiving circuitry configured to receive, from said data management entity, said information on said at least one network element.

Item 20. The apparatus according to Item 18 or 19, further comprising:
ascertaining circuitry configured to ascertain whether said analytics information are required to be provided by said second network; and
transmitting circuitry configured to transmit, if said analytics information is required to be provided by said second network, said second demand for said analytics information towards said second network.

Item 21. The apparatus according to Item 20, further comprising: discovering circuitry configured to discover a data analytics function entity in said second network, the data analytics function entity having a predetermined capability; and
sending circuitry configured to send said second demand for said analytics information towards said data analytics function entity.

Item 22. The apparatus according to Item 21, wherein said predetermined capability is a roaming entry capability.

Item 23. The apparatus according to any of Items 18 to 22, further comprising:
receiving circuitry configured to receive, from said second network, a first analytics information message including said analytics information.

Item 24. The apparatus according to Item 23, wherein said first analytics information message is a first analytics response or a first analytics notification.

Item 25. The apparatus according to Item 23 or 24, further comprising:
transmitting circuitry configured to transmit a second analytics information message including said analytics information.

Item 26. The apparatus according to Item 25, wherein said second analytics information message is a second analytics response or a second analytics notification.

Item 27. The apparatus according to any of Items 18 to 26, wherein
said at least one network element is an access and mobility management function entity or a session management function entity; and/or
said first demand is a first analytics request or a first analytics subscription; and/or
said second demand is a second analytics request or a second analytics subscription; and/or
said information on said at least one network element includes at least one network element identifier corresponding to said at least one network element.

Item 28. An apparatus in a second network, the apparatus comprising:
receiving circuitry configured to receive a first demand for analytics information in relation to a first network based terminal roaming in said second network, wherein said first demand includes information on at least one network element in said second network, said at least one network element serving said terminal; and
   transmitting circuitry configured to transmit a first analytics information message including said analytics information.

Item 29. The apparatus according to Item 28, further comprising: collecting circuitry configured to collect data from said at least one network element; and
deriving circuitry configured to derive said analytics information based on said data.

Item 30. The apparatus according to Item 28, further comprising:
transmitting circuitry configured to transmit a second demand for said analytics information towards a data analytics function, wherein said second demand includes said information on said at least one network element.

Item 31. The apparatus according to Item 30, wherein said second demand is a second analytics request or a second analytics subscription.

Item 32. The apparatus according to Item 30 or 31, further comprising:
receiving circuitry configured to receive, from said data analytics function, a second analytics information message including said analytics information.

Item 33. The apparatus according to Item 32, wherein said second analytics information message is a second analytics response or a second analytics notification.

Item 34. The apparatus according to any of Items 28 to 33, wherein
said at least one network element is an access and mobility management function entity or a session management function entity; and/or
said first demand is a first analytics request or a first analytics subscription; and/or
said first analytics information message is a first analytics response or a first analytics notification; and/or
said information on said at least one network element includes at least one network element identifier corresponding to said at least one network element.

Item 35. An apparatus in a first network, the apparatus comprising: at least one processor;
at least one memory including computer program code; and
at least one interface configured for communication with at least another apparatus;
the at least one processor, with the at least one memory and the computer program code, being configured to cause the apparatus to perform:
receiving a first demand for analytics information in relation to a terminal roaming in a second network;
determining information on at least one network element in said second network, said at least one network element serving said terminal; and
deciding to transmit a second demand for said analytics information towards said second network, wherein said second demand includes said information on said at least one network element.

Item 36. The apparatus according to Item 35, wherein said determining comprises:
inquiring, from a data management entity, said information on said at least one network element; and
receiving, from said data management entity, said information on said at least one network element.

Item 37. The apparatus according to Item 35 or 36, wherein said deciding, comprises ascertaining whether said analytics information are required to be provided by said second network, and wherein the at least one processor, with the at least one memory and the computer program code, being configured to cause the apparatus to perform:
transmitting, if said analytics information are required to be provided by said second network, said second demand for said analytics information towards said second network.

Item 38. The apparatus according to Item 37, wherein the at least one processor, with the at least one memory and the computer program code, being configured to cause the apparatus to perform:
discovering a data analytics function entity in said second network, the data analytics function entity having a predetermined capability, wherein said transmitting comprises sending said second demand for said analytics information towards said data analytics function entity.

Item 39. The apparatus according to Item 38, wherein said predetermined capability is a roaming entry capability.

Item 40. The apparatus according to any of Items 35 to 39, wherein the at least one processor, with the at least one memory and the computer program code, being configured to cause the apparatus to perform:
receiving, from said second network, a first analytics information message including said analytics information.

Item 41. The apparatus according to Item 40, wherein said first analytics information message is a first analytics response or a first analytics notification.

Item 42. The apparatus according to Item 40 or 41, wherein the at least one processor, with the at least one memory and the computer program code, being configured to cause the apparatus to perform:
transmitting a second analytics information message including said analytics information.

Item 43. The apparatus according to Item 42, wherein said second analytics information message is a second analytics response or a second analytics notification.

Item 44. The apparatus according to any of Items 35 to 43, wherein
said at least one network element is an access and mobility management function entity or a session management function entity; and/or
said first demand is a first analytics request or a first analytics subscription, and/or
said second demand is a second analytics request or a second analytics subscription, and/or
said information on said at least one network element includes at least one network element identifier corresponding to said at least one network element.

Item 45. An apparatus in a second network, the apparatus comprising:
at least one processor,
at least one memory including computer program code, and
at least one interface configured for communication with at least another apparatus, the at least one processor, with the at least one memory and the computer program code, being configured to cause the apparatus to perform:
receiving a first demand for analytics information in relation to a first network based terminal roaming in said second network, wherein said first demand includes information on at least one network element in said second network, said at least one network element serving said terminal; and transmitting a first analytics information message including said analytics information.

Item 46. The apparatus according to Item 45, wherein the at least one processor, with the at least one memory and the computer program code, being configured to cause the apparatus to perform:
collecting data from said at least one network element; and
deriving said analytics information based on said data.

Item 47. The apparatus according to Item 45, wherein the at least one processor, with the at least one memory and the computer program code, being configured to cause the apparatus to perform:
transmitting a second demand for said analytics information towards a data analytics function, wherein said second demand includes said information on said at least one network element.

Item 48. The apparatus according to Item 47, wherein said second demand is a second analytics request or a second analytics subscription.

Item 49. The apparatus according to Item 47 or 48, wherein the at least one processor, with the at least one memory and the computer program code, being configured to cause the apparatus to perform:
receiving, from said data analytics function, a second analytics information message including said analytics information.

Item 50. The apparatus according to Item 49, wherein said second analytics information message is a second analytics response or a second analytics notification.

Item 51. The apparatus according to any of Items 45 to 50, wherein
said at least one network element is an access and mobility management function entity or a session management function entity; and/or
said first demand is a first analytics request or a first analytics subscription; and/or
said first analytics information message is a first analytics response or a first analytics notification; and/or
said information on said at least one network element includes at least one network element identifier corresponding to said at least one network element.

Item 52. An apparatus in a first network, the apparatus comprising:
means for receiving a first demand for analytics information in relation to a terminal roaming in a second network;
means for determining information on at least one network element in said second network, said at least one network element serving said terminal; and
means for deciding to transmit a second demand for said analytics information towards said second network, wherein said second demand includes said information on said at least one network element.

Item 53. The apparatus according to Item 52, further comprising:
means for inquiring, from a data management entity, said information on said at least one network element, and
means for receiving, from said data management entity, said information on said at least one network element.

Item 54. The apparatus according to Item 52 or 53, further comprising:
means for ascertaining whether said analytics information are required to be provided by said second network; and
means for transmitting, if said analytics information are required to be provided by said second network, said second demand for said analytics information towards said second network.

Item 55. The apparatus according to Item 54, further comprising:
means for discovering a data analytics function entity in said second network, the data analytics function entity having a predetermined capability; and
means for sending said second demand for said analytics information towards said data analytics function entity.

Item 56. The apparatus according to Item 55, wherein said predetermined capability is a roaming entry capability.

Item 57. The apparatus according to any of Items 52 to 56, further comprising:
means for receiving, from said second network, a first analytics information message including said analytics information.

Item 58. The apparatus according to Item 57, wherein said first analytics information message is a first analytics response or a first analytics notification.

Item 59. The apparatus according to Item 57 or 58, further comprising:
means for transmitting a second analytics information message including said analytics information.

Item 60. The apparatus according to Item 59, wherein said second analytics information message is a second analytics response or a second analytics notification.

Item 61. The apparatus according to any of Items 52 to 60, wherein
said at least one network element is an access and mobility management function entity or a session management function entity; and/or
said first demand is a first analytics request or a first analytics subscription, and/or
said second demand is a second analytics request or a second analytics subscription; and/or
said information on said at least one network element includes at least one network element identifier corresponding to said at least one network element.

Item 62. An apparatus in a second network, the apparatus comprising:
means for receiving a first demand for analytics information in relation to a first network based terminal roaming in said second network, wherein said first demand includes information on at least one network element in said second network, said at least one network element serving said terminal; and
means for transmitting a first analytics information message including said analytics information.

Item 63. The apparatus according to Item 62, further comprising:
means for collecting data from said at least one network element; and means for deriving said analytics information based on said data.

Item 64. The apparatus according to Item 62, further comprising:
means for transmitting a second demand for said analytics information towards a data analytics function, wherein said second demand includes said information on said at least one network element.

Item 65. The apparatus according to Item 64, wherein said second demand is a second analytics request or a second analytics subscription.

Item 66. The apparatus according to Item 64 or 65, further comprising:
means for receiving, from said data analytics function, a second analytics information message including said analytics information.

Item 67. The apparatus according to Item 66, wherein said second analytics information message is a second analytics response or a second analytics notification.

Item 68. The apparatus according to any of Items 62 to 67, wherein
said at least one network element is an access and mobility management function entity or a session management function entity; and/or
said first demand is a first analytics request or a first analytics subscription; and/or
said first analytics information message is a first analytics response or a first analytics notification; and/or
said information on said at least one network element includes at least one network element identifier corresponding to said at least one network element.

Item 69. A computer program product comprising computer-executable computer program code which, when the program is run on a computer, is configured to cause the computer to carry out the method according to any one of Items 1 to 10 or 11 to 17.

Item 70. The computer program product according to Item 69, wherein the computer program product comprises a computer-readable medium on which the computer-executable computer program code is stored, and/or wherein the program is directly loadable into an internal memory of the computer or a processor thereof.

### LIST OF ACRONYMS AND ABBREVIATIONS

3GPP Third Generation Partnership Project
AF application function
AMF access and mobility function
GUAMI globally unique access and mobility function identifier
HPLMN home public land mobile network
H-PCF home policy control function
H-RE-NWDAF home roaming entry network data analytics function
NEF network exposure function
NF network function
NRF network repository function
NWDAF network data analytics function
OAM operations, administration and maintenance
PLMN public land mobile network
RE-NWDAF roaming entry network data analytics function
SMF session management function
UDM unified data management
UE user equipment
UECM user equipment context management
VPLMN visited public land mobile network
V-RE-NWDAF visited roaming entry network data analytics function.

1-21. (canceled)

22. An apparatus for a first network, the apparatus comprising:
at least one processor; and
at least one memory storing instructions which, when executed by the at least one processor, cause the apparatus to perform operations, the operations comprising:
receiving a first demand for analytics information about a terminal roaming in a second network;
determining information about at least one network element of the second network, the at least one network element serving the terminal; and
deciding to transmit a second demand for the analytics information towards the second network, wherein the second demand includes the information about the at least one network element.

23. The apparatus according to claim 22, wherein the determining comprises
requesting, from a data management entity, the information about the at least one network element; and
receiving, from the data management entity, the information about the at least one network element.

24. The apparatus according to claim 22, wherein the deciding comprises:
determining whether the analytics information are required to be provided by the second network;
based on determining that the analytics information are required to be provided by the second network, transmitting towards the second network, the second demand for the analytics information towards the second network.

25. The apparatus according to claim 24, wherein the operations further comprise:
discovering a data analytics function entity of the second network, the data analytics function entity having a predetermined capability; and
wherein the transmitting comprises:
sending the second demand for the analytics information towards the data analytics function entity that is discovered.

26. The apparatus according to claim 25, wherein the predetermined capability is a roaming entry capability.

27. The apparatus according to claim 22, wherein the operations further comprise:
receiving, from the second network, a first analytics information message including the analytics information.

28. The apparatus according to claim 27, wherein the first analytics information message is a first analytics response or a first analytics notification.

29. The apparatus according to claim 27, wherein the operations further comprise:
transmitting a second analytics information message including the analytics information.

30. The apparatus according to claim 29, wherein the second analytics information message is a second analytics response or a second analytics notification.

31. The apparatus according to claim 22, wherein the at least one network element is an access and mobility management function entity or a session management function entity.

32. The apparatus according to claim 22, wherein the first demand is a first analytics request or a first subscription for analytics.

33. The apparatus according to claim 22, wherein the second demand is a second analytics request or a second subscription for analytics.

34. The apparatus according to claim 22, wherein the information about the at least one network element includes at least one network element identifier corresponding to the at least one network element.

35. An apparatus for a second network, the apparatus comprising:
at least one processor; and
at least one memory storing instructions which, when executed by the at least one processor, causes the apparatus to perform operations, the operations comprising:
receiving a first demand for analytics information in relation to a first network based terminal roaming in the second network, wherein the first demand includes information about at least one network element in the second network, the at least one network element serving the terminal; and
transmitting a first analytics information message including the analytics information.

36. The apparatus according to claim 35, wherein the operations further comprise:
collecting data from the at least one network element, and
deriving the analytics information based on the data.

37. The apparatus according to claim 35, wherein the operations further comprise:
transmitting a second demand for the analytics information towards a data analytics function, wherein the second demand includes the information about the at least one network element.

38. The apparatus according to claim 37, wherein the second demand is a second analytics request or a second analytics subscription.

39. The apparatus according to claim 35, wherein the operations further comprise:
receiving, from the data analytics function, a second analytics information message including the analytics information.

40. The apparatus according to claim 35, wherein the at least one network element is an access and mobility management function entity or a session management function entity.

41. The apparatus of claim 35, wherein the first demand is a first analytics request or a first analytics subscription.

42. The apparatus of claim 35, wherein:
the first analytics information message is a first analytics response or a first analytics notification; or
the information about the at least one network element includes at least one network element identifier corresponding to the at least one network element.
